(19) United States
(12) Patent Application Publication
(10) Pub. No.: US 2024/0098043 A1
(43) Pub. Date: Mar. 21, 2024

(54) Improved Architecture Supporting Chats Between Remote Employees

(71) Applicant: Centrical, New York, NY (US)

(72) Inventors: Doron NEUMANN, Tel Mond (IL); Gal RIMON, Ramat Hasharon (IL)

(21) Appl. No.: 17/933,182

(22) Filed: Sep. 19, 2022

(51) Int. Cl. H04L 51/04; H04L 51/02

(52) U.S. Cl. CPC H04L 51/04; H04L 51/02

(57) ABSTRACT

A system supporting conversations between users, the system comprising computer memory typically including plural records of plural conversations between users respectively; and a hardware processor typically providing conversation functionality which enables at least first and second web platform users to conduct at least one conversation C with one another. The hardware processor is configured, typically responsive to mention of at least one business object in the conversation C, to show, to the first user, data pertaining typically to the business object which is typically specific to the first user; and to show, to the second user, data pertaining typically to the business object which is typically specific to the second user.

### FIELD OF THIS DISCLOSURE

The present invention relates generally to software and more particularly to chat software.

### BACKGROUND

Remote Dictionary server, aka Redis, is an example of a data platform that facilitates storage of plural data types and big data. Dictionary is a key-value data type and Redis stores data in a key-value format. Redis is an in-memory and single-threaded datastore which supports unstructured as well-structured data.

MongoDB is an example of a relational e.g., NoSQL database, which, rather than taking input values in a table format, accepts values in BSON format. Mongo data is document-oriented; data is stored in the form of collections and documents.

References to Redis or to MongoDB herein are not, of course, intended to be limiting.

Chat room servers are known. For example, a method for setting up a chat room server which allows multiple clients to connect to the chat using a client-side script is described here: Simple Chat Room using Python—GeeksforGeeks. The described solution uses sockets and threading although this is not intended to be limiting. As described (omitting illustrations for brevity):

“Sockets can be thought of as endpoints in a communication channel that is bi-directional and establishes communication between a server and one or more clients. Here, we set up a socket on each end and allow a client to interact with other clients via the server. The socket on the server side associates itself with some hardware port on the server-side. Any client that has a socket associated with the same port can communicate with the server socket.

( . . . ) A thread is a sub-process that runs a set of commands individually of any other thread. So, every time a user connects to the server, a separate thread is created for that user, and communication from the server to the client takes place along individual threads based on socket objects created for the sake of the identity of each client.

We will require two scripts to establish this chat room. One to keep the serving running, and another that every client should run in order to connect to the server.

( . . . ) The server-side script will attempt to establish a socket and bind it to an IP address and port specified by the user (windows users might have to make an exception for the specified port number in their firewall settings, or can rather use a port that is already open). The script will then stay open and receive connection requests and will append respective socket objects to a list to keep track of active connections. Every time a user connects.

a separate thread will be created for that user. In each thread, the server awaits a message and sends that message to other users currently on the chat. If the server encounters an error while trying to receive a message from a particular thread, it will exit that thread.

( . . . ) This server can be set up on a local area network by choosing any on the computer to be a server node, and using that computer's private IP address as the server IP address.

For example, if a local area network has a set of private IP addresses assigned ranging from 192.168.1.2 to 192.168.1.100, then any computer from these 99 nodes can act as a server, and the remaining nodes may connect to the server node by using the server's private IP address. Care must be taken to choose a port that is currently not in usage. For example, port 22 is the default for ssh, and port 80 is the default for HTTP protocols. So these two ports preferably, shouldn't be used or reconfigured to make them free for usage. However, if the server is meant to be accessible beyond a local network, the public IP address would be required for usage. This would require port forwarding in cases where a node from a local network (node that isn't the router) wishes to host the server. In this case, we would require any requests that come to the public IP addresses to be re-routed towards our private IP address in our local network, and would hence require port forwarding. For more reading on port forwarding: link To run the script, simply download it from the GitHub link specified at the bottom of the post, and save it at a convenient location on your computer. ( . . . ).

Below is the Server side script that must be run at all times to keep the chatroom running ( . . . ).

The client-side script will simply attempt to access the server socket created at the specified IP address and port. Once it connects, it will continuously check as to whether the input comes from the server or from the client, and accordingly redirects output. If the input is from the server, it displays the message on the terminal. If the input is from the user, it sends the message that the user enters to the server for it to be broadcasted to other users. This is the client-side script, that each user must use in order to connect to the server. ( . . . )
a server has been initialized on the left side of the terminal and a client script on the right side of the terminal. (Splitting of terminal done using tmux, ‘sudo apt-get install tmux’). For initialization purposes, you can see that whenever a message is sent by a user, the message along with IP address is shown on the server-side ( . . . ). The below picture has a basic conversation between two people on the same server. Multiple clients can connect to the server in the same way”.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented as appropriate.

Certain embodiments seek to provide an improved architecture supporting conversations between users, which is particularly suited to facilitating dialogue between remote employees or remote team-members.

Certain embodiments seek to provide a system which facilitates conversation between users and wherein the system, responsive to mention of business object/s, such as KPIs, in conversation, presents at least one user with contextual data and/or enables at least one user to perform contextual actions on these object/s.

For example, during a conversation, a Manager user may mention a specific KPI in a conversation (e.g. non-human entity). Responsively, the system then presents to each user participating in the conversation, their own KPI values for the specific KPI, e.g., when users hover over the KPI, and/or enables users to perform actions on that KPI e.g., enables user/s to send a progress report pertaining to that KPI.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operation and instead, the remote processor P itself may receive output/s of portion/s of the operation from yet another processor/s P′, may be deployed off-shore relative to P, or “on a cloud”, and so forth.

The present invention typically includes at least the following embodiments:
Embodiment 1. A system supporting conversations between users, the system comprising computer memory including plural records of plural conversations between users respectively; and/or a hardware processor which may provide conversation functionality which enables at least first and second web platform users to conduct at least one conversation C with one another; wherein the hardware processor is configured, e.g. responsive to mention of at least one business object in the conversation C, to show, to the first user, data pertaining to the business object which is specific to the first user; and to show, to the second user, typically simultaneously, data pertaining to the business object which is specific to the second user.
Embodiment 2. A system according to any of the preceding embodiments wherein the hardware processor is also configured to enable the first and second users to perform respective actions on the at least one business objects and wherein data pertaining to the actions is stored in the computer memory in a record of the conversation C.

This is advantageous because, for example, weeks or months after a given conversation between a manager and her or his team has occurred, the manager can access the conversation's record in the computer memory and can determine, say, which of the participants sent a project report.
Embodiment 3. A system according to any of the preceding embodiments wherein an action performed by the first user comprises sending a project report reflecting progress on aspects of a project which pertain to the first user, to at least one user, other than the first user, who is participating in the conversation C.
Embodiment 4. A system according to any of the preceding embodiments wherein the hardware processor shows data to at least the first user when the first user hovers over the mention of the business object in conversation C.
Embodiment 5. A system according to any of the preceding embodiments wherein the business object mentioned in the conversation comprises a KPI which has different values for the first user and for the second user, and wherein the hardware processor shows the values of the KPI for the first user, to the first user, and shows the values of the KPI for the second user, to the second user.
Embodiment 6. A system according to any of the preceding embodiments wherein the business object mentioned in the conversation comprises one of the following: a Campaign, a Learning Item, a Challenge, a Leaderboard (or scoreboard showing names and current scores for plural competitors e.g. system users), and a Coaching Activity.
Embodiment 7. A system according to any of the preceding embodiments wherein at least one user's rooms with information on each room loads in real time because the system maintains, in cache, a list of rooms for each user, including metadata regarding the rooms.
Embodiment 8. A system according to any of the preceding embodiments wherein the metadata is updated in real time.
Embodiment 9. A system according to any of the preceding embodiments wherein the hardware processor includes a conversation service and conversation user interface, and wherein updates of conversation rooms and users are pushed from the conversation service to the conversation user interface. According to certain embodiments, the hardware processor also comprises a conversation adaptor.
Embodiment 10. A system according to any of the preceding embodiments wherein at least one user performs at least one action from among the actions without exiting the conversation.

An example action may be that without exiting a conversation C, a user may start a new conversation about a given item, say with her manager (who may or may not be a participant in conversation C), yielding a new conversation which may not have existed prior to conversation C and may be begun without first exiting conversation C.
Embodiment 11. A method supporting conversations between users, the method comprising: Providing computer memory which may include plural records of plural conversations between users respectively; and/or Using a hardware processor to provide conversation functionality which may enable at least first and second web platform users to conduct at least one conversation C with one another; wherein the hardware processor is configured, responsive to mention of at least one business object in the conversation C, to show, to the first user, data pertaining to the business object which is specific to the first user; and to show, to the second user, data pertaining to the business object which is specific to the second user.

Typically, each time one of the plural records, which records a conversation between the first user and other users, is accessed retroactively by the first user, the method shows the first user data pertaining to the business object which is specific to her, and each time the same record is accessed retroactively by one of the other users, the method shows each of the other users, data pertaining to the business object which is specific to him.
Embodiment 12. A computer program product, comprising a non-transitory tangible computer readable medium having computer readable program code embodied therein, the computer readable program code adapted to be executed to implement a method supporting conversations between users, the method comprising: Providing computer memory including plural records of plural conversations between users respectively; and Using a hardware processor to provide conversation functionality which enables at least first and second web platform users to conduct at least one conversation C with one another; wherein the hardware processor is configured, responsive to mention of at least one business object in the conversation C, to show, to the first user, data pertaining to the business object which is specific to the first user; and to show, to the second user, data pertaining to the business object which is specific to the second user.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of, at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Certain embodiments of the present invention are illustrated in the following drawings; in the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language or may comply with any conventional query language or protocol. Blocks illustrated in one diagram may if desired in combination with blocks illustrated in other diagrams. Specifically:

FIGS. 1, 7, 11, 13 and 14 are simplified block diagram illustrations of embodiments; all or any subset of illustrated blocks may be provided, with any suitable data communication relationships therebetween e.g. as shown;

FIGS. 2a, 2b. 3-6, 9-10 are tables helpful in understanding certain embodiments and it is appreciated that all or any subset of the table-cells, rows and columns illustrated may be provided:

FIG. 8 is a simplified flowchart illustration of a method according to an embodiment; all or any subset of the illustrated operations may be provided, in any suitable order e.g. as shown; and

FIG. 12 is a swimlane diagram of an embodiment.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown, tables herein may include all or any subset of the fields and/or records and/or cells and/or rows and/or columns described.

In the swim-lane diagrams, it is appreciated that any order of the operations shown may be employed rather than the order shown, however preferably, the order is such as to allow utilization of results of certain operations by other operations by performing the former before the latter, as shown in the diagram.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (E.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with: methods shown and described herein, or any suitable subset, in any suitable order, of the operations included in such methods, or in accordance with methods known in the art.

Any logical functionality described herein may be implemented as a real time application if and as appropriate and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

“Chat” and “conversation” are used herein generally interchangeably.

“Room” herein is used to include chatrooms including their representation in computer memory. An example method for setting up a chatroom server is described here: www.geeksforgeeks.org/simple-chat-room-using-python/.

The term “business object” is used herein to include an entity within a multitiered software application which operates in conjunction with data access and domain logic layers. Alternatively, references to business objects herein may be replaced by references to prototypical objects. There may be a finite set of business objects (e.g. KPIs, status reports, inventories, electronic accounts, Mission, Leaderboard, Badge, Learning Item, Coaching Activity. Contribution) that the platform is pre-programmed to know/recognize/use e.g., if these objects are defined in or via an API communicating with external software which defines various such objects.
“Context” may include any combination of (e.g. all or any subset of) a prototypical object and/or a user and/or a time period.
“User contextual data” may include any data value mapped to a context. For example, KPI A, User U, and Time period T, the user contextual data may be D1.
“Graphical contextual representation” may include any representation whereby user contextual data is presented to a user graphically.
“contextual actions” may for example include sending information (e.g. sending a status report, or line/s of text), typically to other conversation participant/s, and/or generating a document, and/or activating certain software or hardware, typically remotely, etc.

“Contextual”; may be used as its plain english language or technical meaning or may be used to refer to data (or an action) pertinent to a given business object and to a given user participating in a given conversation. For example, if the business object is a kpi, “contextual” data may include the kpi's values for a certain user in the conversation and a “contextual” action may (for example) include a user's sending his own values for a certain kpi mentioned, e.g. During the conversation, to at least one user (e.g. Conversation participant) other than herself/himself . . . If a manager M manages 2 users U1 and U2, the manager may write in the chat: Lets focus on @KPI1; responsively, each of these users may see their own data on KPI1 and/or their own contextual actions related to KPI1.

An example Conversation Module, configured in accordance with certain embodiments, is now described in detail; the architecture herein yields a Conversation feature which, typically, is configured to present contextual data to user/s, responsive to mention of business objects in conversations, and/or to enable at least one user to perform contextual actions on these object/s.

The conversation feature within the platform shown and described herein allows users of the platform to communicate among themselves, say for example in defined product scopes e.g., manager-employee, team, a common goal like a challenge, or any other platform or business scope.

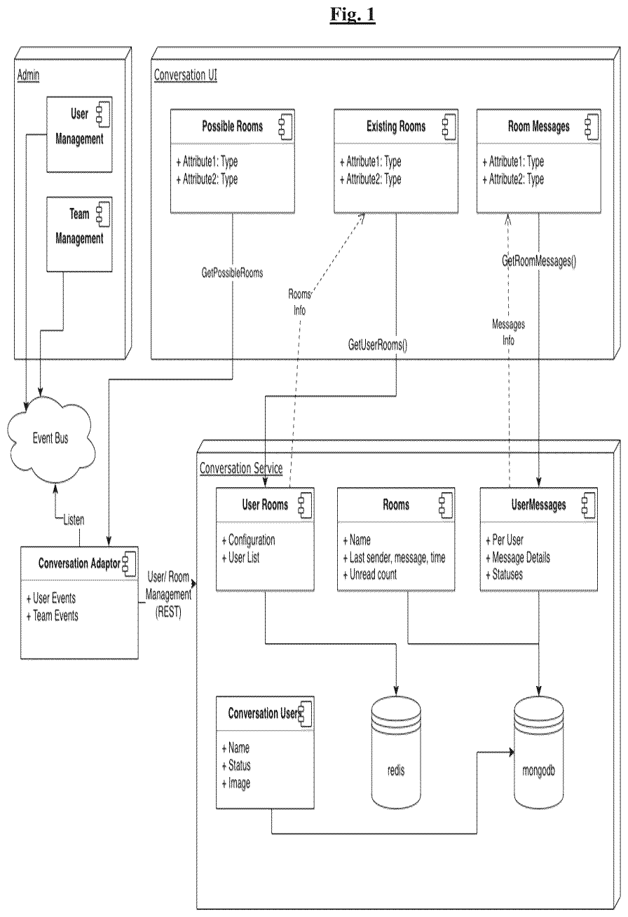

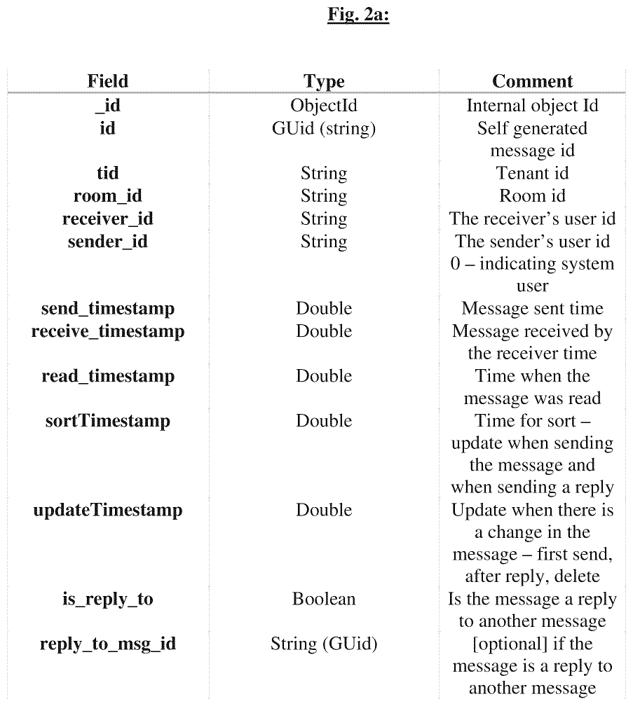

FIG. 1 is simplified block diagram of a conversation service; all or any subset of the illustrated blocks, here and in other diagrams herein, may be provided in practice.

The conversation UI of FIG. 1 typically comprises a UI component, which may be embedded within a Desktop application and a mobile application, and which is typically configured to display all or any subset of the following information to the user:
Existing conversation rooms
Possible conversation rooms
Display conversation messages upon room selection
   The conversation UI may also support actions e.g.:
Managing a conversation room—start/delete/mute etc.
Sending messages to the room
Performing ‘Call to Action’ from messages
Search

The conversation service of FIG. 1 typically manages conversation rooms and conversation users. It does that in an encapsulated manner, without any specific system logic but rather a general User/Room/Message distribution.

The conversation service relies on the Conversation Adapter for management, meaning, creation of users, rooms, and their relations are up to the adapter.

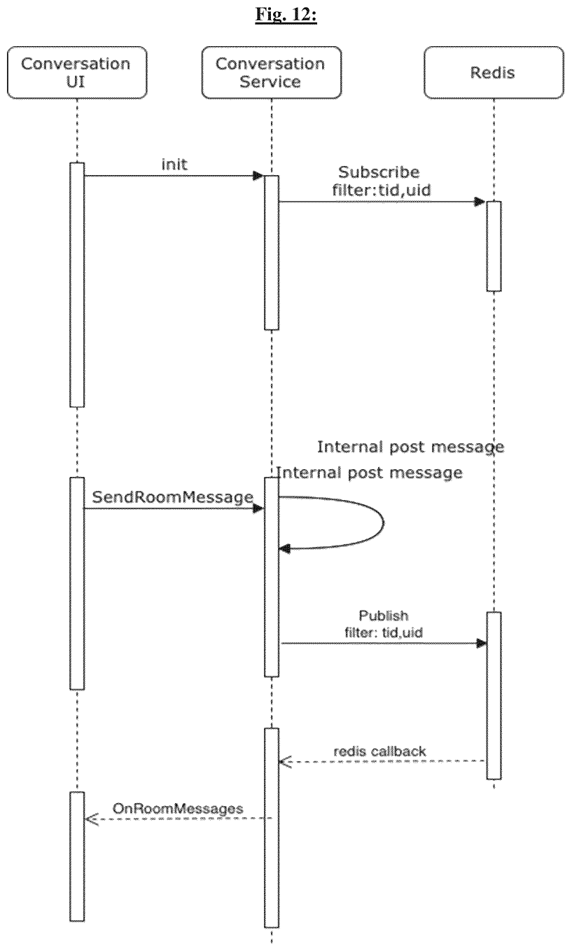

The conversation service may comprise a micro service written in Node, may be deployed in a Docker container environment, may be deployed to ECS servers in a redundant way, and may expose an HTTPS interface via a main load balancer configured to forward all conversations/traffic to the Conversation Service container e.g., as shown in FIG. 13.

The conversation adapter of FIG. 1 typically bridges between the system logic and entities and the conversation entities. The adapter listens to the event bus (FIG. 1) and acts upon relevant messages. For example, upon a message of user switching a team, the adapter may move this user to the right conversation room (creating it, if needed).

The conversation system is typically designed with a Micro service approach and separation of concerns and/or powers. The conversation service typically only manages rooms, users of these rooms, and storage and distribution of messages to these rooms/users.

Typically, another conversation system that an end user may have, such as Microsoft Teams, Slack, SAP, and Jam, may be used instead, since the adapter and conversation service are separated, and the adapter is, typically, configured to work with an abstraction of the conversation service (interface).

Typically, the user's rooms, with information on each room, loads in real time without any processing e.g., because the system may maintain, in cache (e.g., Redis) a list of rooms for each user with required details, and may update them in real time. All updates of conversation rooms and users may be pushed from the conversation service to the conversation UI. The Conversation UI typically requests data, and data is then pushed via a web socket (say) back-channel. Changes in conversation entities are typically pushed to all relevant online UI clients. Data is typically not normalized to ensure quick and processing-free delivery.

Any suitable database/s may be used for the conversation feature, such as but not limited to Mongo and/or Redis, where MongoDB is an example of a NoSQL document database for storing user messages. MongoDB is useful as a document database because it can be provided as a managed service in AWS. Couchbase, however, is another alternative. Redis is an example of a NoSQL key/value database for storing conversation rooms and user conversation room information.

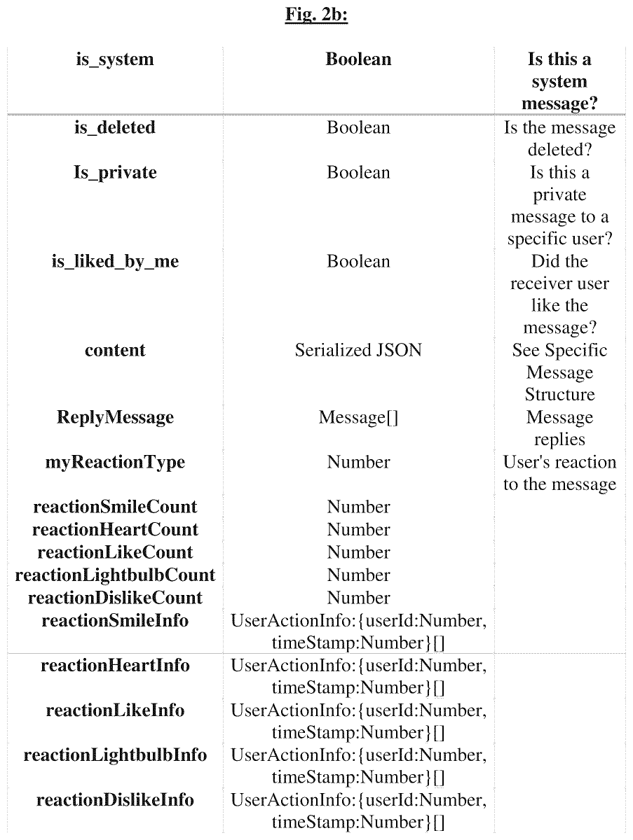

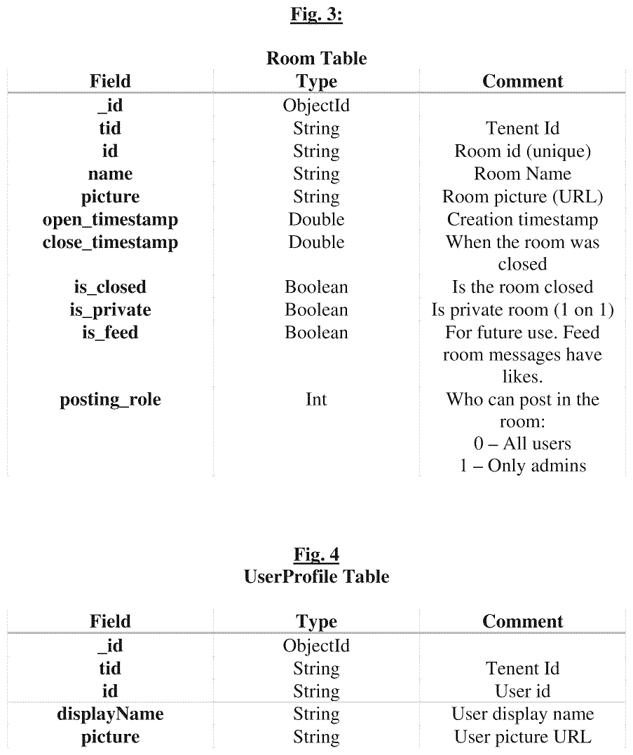

For example, the tables of FIGS. 2a-4 may be stored in Mongo, whereas the tables of FIGS. 5-6 may be stored in Redis.

FIG. 2 is an example Messages_v1 Table, including a list of fields of various types, all or any subset of which may be provided. It is appreciated that “is liked by me” may be used to decide whether the ‘like’ button is selected or not.

Indexes may include:
1. [Compound] tid, receiverId, roomId, sortTimestamp—used to take all messages for a specific room and user. Sorted by sortTimestamp; and/or
2. [Compound] messageId, receiverId, replyMessages—used to update a single message and query replies.

FIG. 3 is an example Room Table, including a list of fields of various types, all or any subset of which may be provided. Indexes: e.g. [Compound] tid,id—Used to look up the room.

FIG. 4 is an example UserProfile Table, including a list of fields of various types, all or any subset of which may be provided. Indexes: e/g/ [Compound] tid,id—Used to look up the user and aggregate with the message.

Redis Database:

FIG. 5 is an example RoomLastMessage structure table, including a list of fields of various types, all or any subset of which may be provided. FIG. 6 is an example RoomLastMessage structure table according to another embodiment, which is configured to extend a room, and includes a list of fields of various types, all or any subset of which may be provided. This typically has all Room properties.

Storage in Redis may include all or any subset of the following:

### RoomLastMessage

set {tid}:room:{roomId}:last JSON.stringify(<Room Structure>)

### Room Subscribers

sadd {tid}:room:{roomId}:subscribers user_id

### UserRoom:

hmset {tid}:user:{user_id}:room:{roomId}<UserRoom Structure>

### UserRoomListids

zadd {tid}:user:{user_id}:roomlist key: room_id score: last_send_timestamp

### UserLastSeen

set {tid}:user:{user_id}:last_seen last_seen_timestamp

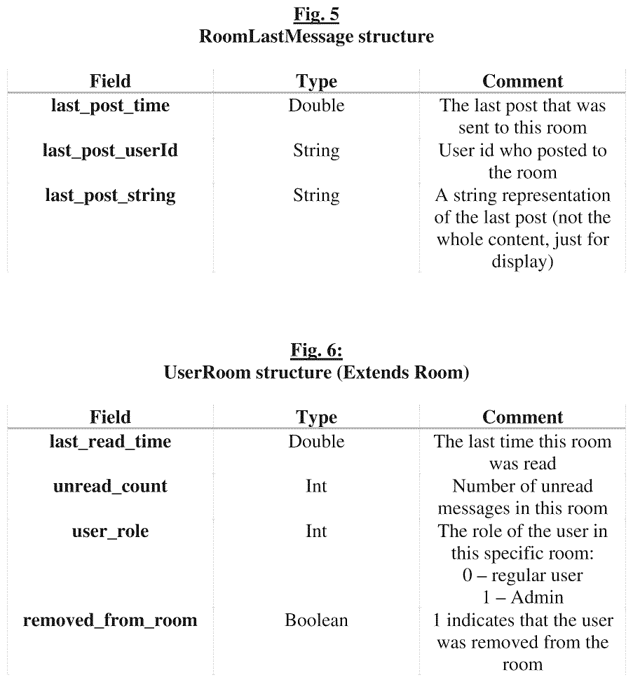

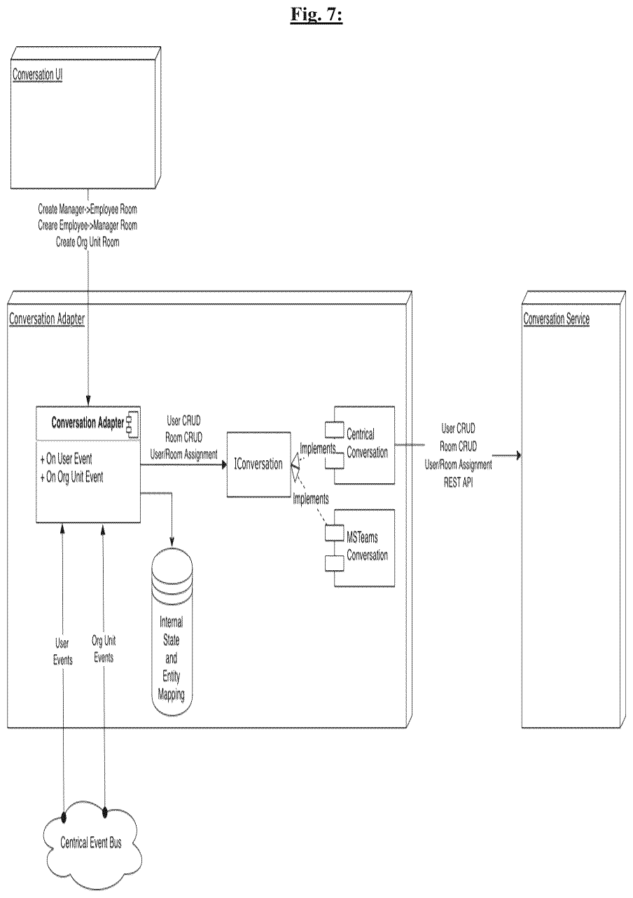

All or any subset of the following conversation components may be provided in practice: any suitable conversation UI e.g. text messaging or voice/video/group calling, similar to whatsapp, Signal, SMS and so forth, conversation adapter (e.g., all or any subset of the blocks in FIG. 7), and conversation service.

The conversation adapter typically facilitates the linkage between the system logic and entities, and the conversation entities. The adapter registers to listen on the system's event bus (FIG. 1). Upon receiving an event, the adapter processes the event including identifying, management commands to be performed on the conversation service, and calls the Conversation Service REST API to perform these.

The adapter may register and process events which affect conversation rooms. For first stage, the conversation rooms may include the following:
User < - - - > Manager Room
Team (Org Unit) Room
   and the events which may affect conversation and trigger an adapter action are typically:
User events: Create/Modify (Display Name, Picture)/Delete and/or
Org Unit Event: Create/Modify (Name)/Delete and/or
User Assigned/Unassigned to Org Unit event

Responsive to user events, the adapter may make the appropriate API calls to the Conversation service to create/update/delete the user, or their details.

The adapter typically does not create any rooms in this case, and instead just updates the user data.

Responsive to Org Unit events, the adapter may:
Create/Modify/Delete the conversation room; and/or
Add/Remove users to this room as needed: and/or
Update internal mapping on room information

Responsive to user assign/unassign to Org unit, if the Org unit has a group mapped to it, the user may be added/removed from the correlating room. If the Org unit room has not yet been created, this event may not cause its creation.

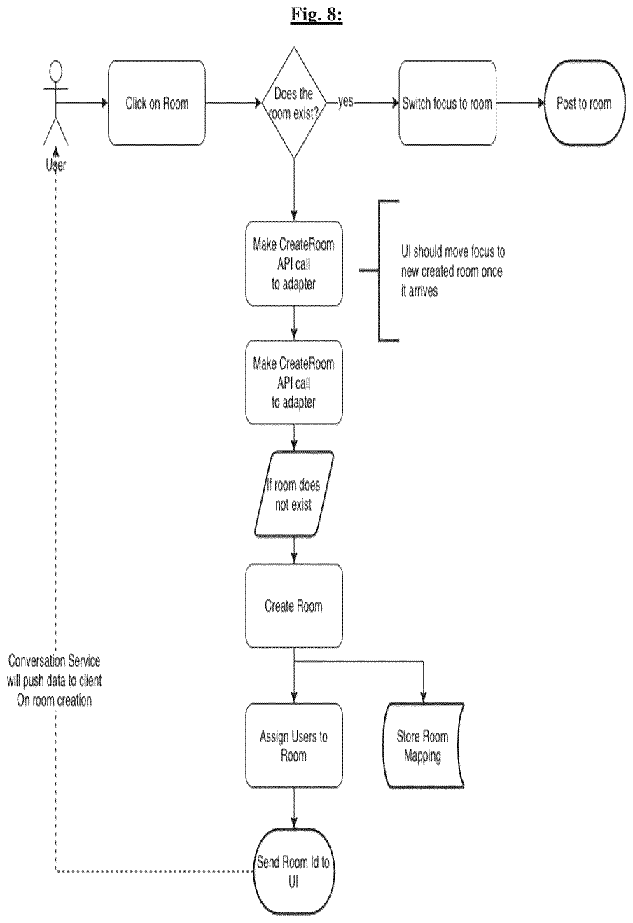

The adapter exposes API enabling the UX to call it and generate a room explicitly. This may occur e.g. when a user wants to send a message to a “potential” room (a room that does not yet exist). In this scenario, the UI may make an API call to the adapter, instructing the adapter to create a room. After validation, the adapter may create the room and may assign all the required users to that room e.g., by performing all or any subset of the operations shown in FIG. 8, in any suitable order e.g., as shown. The adapter and service may communicate via a secure channel which may be authenticated by an API key+secret. According to an embodiment, the adapter uses a management API key/token in order to call the Conversation Service management REST API. Authentication may be with a key/secret admin account managed internally in the conversation service.

The Conversation Service typically comprises a micro-service which manages conversation rooms, conversation users, and distribution of messages. To facilitate superior performance, the system is typically configured to insert and/or update and/or query the user and/or room and/or message data, e.g., as per all or any subset of the following use cases. First, Service Use Cases are described; all or any subset of the following service use cases may be provided:

Get User Room list

Upon a user opening the conversation, a list of rooms that the user is part of is pushed to the conversation UI. The process of list creation may include all of any subset of the following operations, suitably ordered e.g., as shown:
1. Get user room ids from UserRoomListids (Redis)
2. For each id:
   2a. Get the UserRoom properties from UserRoom (Redis)
   2b. If the UserRoom.removed_from_room==1:
      Get the room last message info from RoomLastMessage (Redis)
   2c. Else
      Get the last message value from UserRoom itself
   2c. Merge the outputs of operations 2b, 2c.
3. Push the list
   If paging is needed, this may be accomplished e.g., by fetching X number of ids from UserRoomListIds.

Get User Room Messages

This process may include all of any subset of the following operations, suitably ordered e.g., as shown:
G1. Query for user messages from UserMessages table aggregated with UserProfile for sender_id (so that sender displayName and picture are part of the message) Data is in MongoDB.
G2. Query the user for image and sender name
G3. Set number of replies from Redis
G4. Return the list
   Query may contain paging information that may be implemented as part of the query.

User Posts a Message to Room

When a user posts a message to a room, data is written, and other flows may be performed (e.g., notification and/or distribution). All or any subset of the following data insert/update operations may occur, in any suitable order e.g., as follows:
P1. The user's UserRoom is fetched, if it does not exist, this means that the user is trying to post to a Room which they are not part of, and this is not permitted.
P2. Insert message to UserMessages with receiver_id=0 (system).
P3. Update the RoomLastMessage structure
P4. Generate a bulk of cloned messages, one for each room subscriber, ready to be inserted into UserMessages (MongoDB), differing from each other by receiver_id.
P5. Insert messages in bulk to UserMessages
P6. For each subscriber:
   Increase unread_count by 1; and/or
   Push notification on user message to Conversation UI.

A Room is Created

To create a room, a call may be made, either with or without a list of user ids. The user ids passed typically must be of users which exist in the UserProfile (MongoDB) table. A user who was not added to the conversation service typically cannot be registered to a room. All or any subset of the following operations may be performed, in any suitable order e.g., as follows:
R1. Room item is created and stored in Rooms (e.g. in MongoDB)
R2. For each subscriber:
   a. A UserRoom is created and stored e.g. in UserRoom (Redis); data is partially copied from the Room.
   b. a New Room is added to UserRoomListids
   d. A subscriber is added to room subscriber list
R3. A system message stating that you and X users joined the room is sent to Room.

A User is Added to a Room

A user that is added to an existing room can typically see all existing messages. Upon adding a user to a room, all or any subset of the following operations may be performed, in any suitable order e.g., as follows:
A1. All room messages (with receiver_id=0) are cloned with receiver_id of the new user (Mongo)
A2. UserRoom is created
A3. A subscriber is added to room subscriber list
A4. A system message that user X has joined is sent to the room.

A User is Removed from a Room

When a user is removed from an existing room, s/he may be able to see messages up to the time before he/she was removed. All or any subset of the following operations may be performed, in any suitable order e.g., as follows:
V1. Remove user from subscriber list
V2. Persist RoomLastMessage values to the user's UserRoom
V3. Send a system message to the room indicating that user was removed.

Because the user has been removed from the room, the system typically does not take the RoomLastMessage current values and instead persists them and uses them from user's UserRoom structure.

User Changes Profile Picture or Display Name

The user's profile picture may appear in 2 places in the conversation:
i. In a private 1-1 (or manager) conversation, the picture may appear in the UserRoom item of the other user in the conversation. For example: UserA(manager) and UserB(employee) are in a manager room. UserA's UserRoom item picture may be UserB's picture and vice versa; and/or
ii. In every UserMessage, the sender's displayName and picture may appear. So, if the user changes the profile picture or their name. All or any subset of the following operations may be performed, in any suitable order e.g., as follows:
C1. Update the new value in the UserProfile table (mongo db).
C2. Fetch the updated user's room list
C3. For each room, check if the room is a 1-1 room. If so, fetch the other's user UserRoom (Redis) record and update the room name (e.g. as shown in FIG. 1) and/or the room's picture.

User Changes Room Picture or Name

A room's name or picture may change, either because their system's corresponding entity name or picture have been changed, or if an option is available (e.g., to admin) to change a picture or name manually. Upon change in room picture or name, all or any subset of the following operations may be performed, in any suitable order e.g., as follows:
N1. Update name/picture in Room (Mongo)
N2. Get the room subscribers list
N3. For each subscriber user, update the picture and name of the UserRoom (Redis)
N4. Send appropriate notifications

User Chooses to Delete a Message

Typically, a regular user is permitted to delete their own message. An admin is permitted to delete any message in the room. A message may be deleted only for me (i.e., the user), or for all. Upon choosing to delete a message:
D1. The <message id for delete> may be established.
D2. A deleted message is;
   Marked as deleted: ‘is deleted’ set to true.
   Content is replaced with a content representing a deleted message
D3. Update the UserMessage (MongoDB) table items.

If delete is “only for me”, then only update the specific message with receiver_id=<me>. If delete is for all, update all messages with id=<message id to delete>

Reply to Message

User replies to a message may be:
From the client getting a message with parentId.
Getting the parent message from Mongo
Verifying send permissions to message
Making sure the parent message is not deleted
Updating all the message copies with $push to the replyMessages in the Mongo
Setting the reply user image
Updating the reply count and message last reply in the Redis
Updating parent message with user image
Publish parent message to users onMessage
Publish reply onMessageReply

Get replies

Getting a reply when a user selects a message may include:
Verifying the user has permission to get message; and/or
Getting replies with pagination using lastMessageSortTimestamp.

Delete a Reply

When deleting a reply message, all or any subset of the following operations may be performed, in any suitable order e.g., as follows:
L1. Delete the reply from the Mongo
L2. Getting the updated message including the reply count the last reply
L3. Update the message with user image
L4. Publish onMessage

React to Message

To add user reaction to a message, all or any subset of the following operations may be performed, in any suitable order e.g., as follows:
T1. Lock for with userid-messageId key. This is for the user not to click on quick and add two reactions, instead of one.
T2. Get the user's message you react on
T3. Check permissions
T4. Add myReactionType to the user's message copy
T5. Update the reaction e.g. by some or all of:
   if it's the same reaction as the current user's reaction, delete that reaction.
   Update myReaction field in the user's message copy
   Add the reaction to the selected reaction count
   Add the userId and timestamp to the selected reaction info
T6. Send client message with the updated reaction for the users that are currently connected to the room.

The term “service API” is used herein to refer to the API that the Conversation UI uses to communicate with the service, and what the service uses to communicate back pushing data to the Conversation UI. A WebSocket (say) communication channel may be used between the Conversation UI and the Conversation Service.

Calls or events from Client to Server may include all or any subset of those presented in the table of FIG. 9. Each call or event may include all or any subset of the parameters presented in FIG. 9.

Calls or events from Server to Client may include all or any subset of those presented in the table of FIG. 10. Each call or event may include all or any subset of the parameters presented in FIG. 10. In FIG. 10, the term “pagination” refers to sending messages to a client in bulk or in chunks: given a large number of messages, plural messages may be loaded in bulk (as pages) instead of all at once.

All or any subset of the illustrated API calls may be provided, and the illustrated Push events may follow them. According to certain embodiment, these events may also be pushed to the Conversation UI without a preceding API call by the UI.

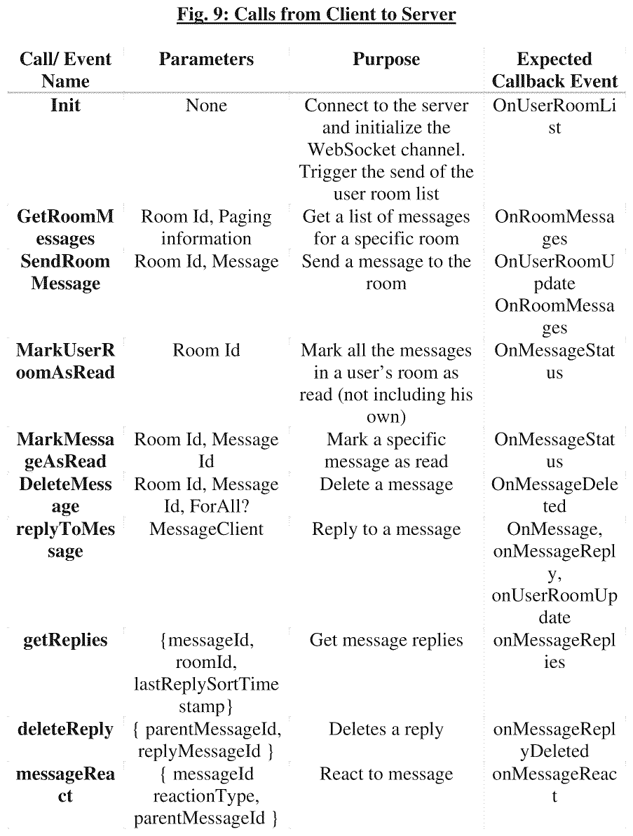

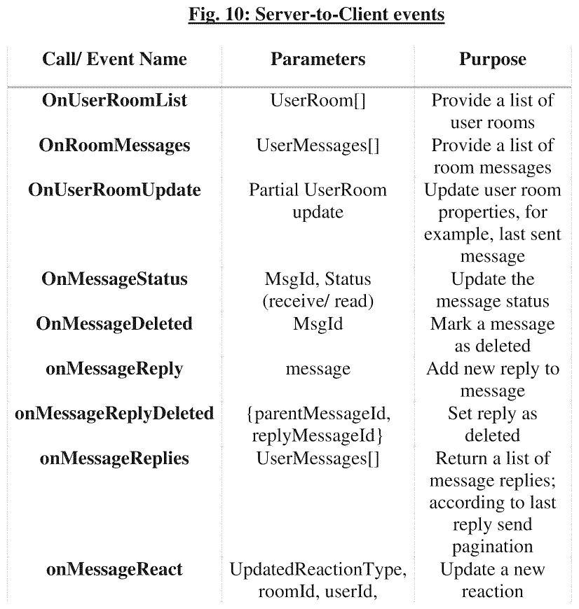

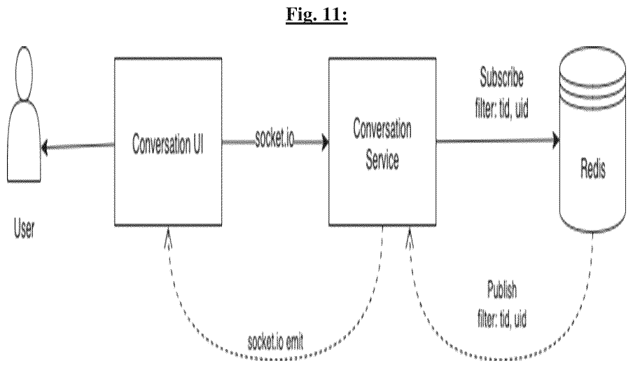

As described, returning data from the Conversation Service to the Conversation UI is typically done by push via WebSocket (say) channel. Thus, push data functionality may be provided, and may be facilitated by the Redis pub-sub mechanism, for example. The WebSocket (say) connection is made to a specific conversation service instance. In the scenario of multiple servers hosting the conversation service, each conversation UI client connects to a single service at random, routed by a load balancer, and maintains the connection. When the Conversation UI sends a message to a room, this message is then typically pushed to all users of this room. Each user's Conversation UI is connected to the Conversation Service, but, not necessarily to the same one, and not necessarily to the one which is currently handling the message sent to the room. To ensure that push notifications sent to each Conversation UI get to their respective correlating Conversation Service, this notification may be published e.g., using the Redis pub-sub mechanism. If each Conversation Service instance subscribes to the Redis when establishing the WebSocket connection with the Conversation UI, this guarantees that the Conversation service receives the published notification, and pushes the notification to its Conversation UI client. An example Push Mechanism Data Flow is shown in FIG. 11. An example Push Mechanism Sequence Diagram is shown, in swim-lane form, in FIG. 12.

The Management REST API exposed by the Conversation Service may be used by the Conversation Adapter in order to perform management operations.

The API may support all or any subset of the following management operations:
Create, Update, Delete user profiles
Create, Update, Delete room
Assign/Unassign user to Room
Get Room By Id
Get User By Id
   Example: The following is an API suggestion:
POST/user
PUT /user/:id
GET /user/:id
DELETE /user/:id
POST /room
PUT /room/:id
GET /room/:id
DELETE /room/:id
POST /assign/room_id/user_id
DELETE /assign/room_id/user_id

Analytics to provide information on conversation usage and utilization: the Conversation Service may provide statistical data e.g. via Analytics API interface which returns analytics data. All or any subset of the following analytic data may be provided by the service:
Total Number of rooms
Total Number of messages sent
Total User Number
Daily Open Rooms
Daily Closed Rooms
Daily Message Count

Any suitable security arrangements may be made. Typically, the service shown and described herein is multi-tenant across all components. Typically, all data is segregated between the tenants with tenant id, and there is no option to run cross-tenant queries or data requests. Typically, the system always validates and maintains tenant context. Databases access may be restricted to the Conversation Service only. Typically, databases are not exposed publicly. Typically, all access to databases must be via SSL. Conversation UI and Conversation Service access may be secure via HTTPS, and may use JWT to authenticate all requests. Push channel may be via SSL and the Conversation UI, and Conversation Adapter may communicate via HTTPS and may use a security token. The Conversation Adapter and Conversation Service may communicate via HTTPS and may use Key+Secret for authentication. All data may be encrypted at rest. Given that users may upload content, the system may be configured for limiting file types and/or origins and/or sizes.

To ensure privacy, an administration is typically able to delete all data related to a specific user upon request. Upon admin user data removal, all or any subset of the following may be performed:
The content of all messages that the user received may be deleted
The content of all the messages that the user sent may be deleted
The user may be unassigned from all rooms
Private one on one rooms may of the user's will be closed
The list of user channels may be deleted
The user may be marked as deleted from the user list
The user's name and picture may be replaced with generic values.

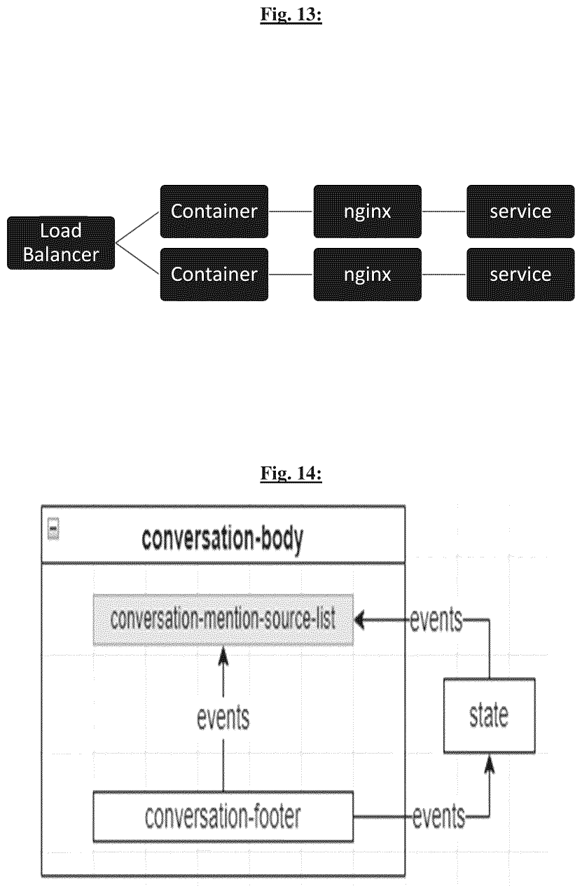

A “mention a member on conversation” feature is now described in detail, with reference to FIG. 14. Conversation may be configured to send notifications to the users that were mentioned in the message. Web may be used to add the ability to mention users in a message. In a WEB architecture implementation, e.g., as shown in FIG. 14, a Conversation-footer typically listens to input and keyboard events, and may, responsively, fire actions that change the state and/or influence conversation-mention-source-list.

Any technology may be used for getting the room users in the connectRoom request. By way of non-limiting example, the system may get the room users only on demand, when users click on the room info button. If there is a concern that big rooms (e.g., 1500 and above) might crash the app, the number of users the server returns to the client may be limited, e.g., to 1500. Notifications may be sent to all room users. A call to getRoomUsers may be added in a connectRoom API. ConnectRoom functionality enables a user to “select room”—the user typically chooses to set focus on a given room and responsively, that room's messages are loaded and/or displayed.

According to an embodiment, a new property (mentions) is added to the Message schema in the MongoDB. Typically, a mentions list is provided, which may include all room users and the room name (e.g., as shown in FIG. 1). The mention options list may be filtered. The mentions list may be saved in the conversation message schema.

According to certain embodiments, responsive to mention of business objects in a conversation between users, the system (e.g., the conversation module described with reference to all or any subset of FIGS. 1-13, shows at least one user from among those users, contextual data, or data relevant to the business object/s (operation vi below) and/or enables users to perform at least one action, e.g., contextual actions, on these objects (operation viii below).

An example flow for effecting this, typically as a run-time method (method which runs in real time or near-real time), is now described; all or any subset of the following operations may be employed, in any suitable order e.g. as follows:

Setup before run-time: KPIs may be set up by each organization using the system shown and described herein to reflect that organization's business processes. Alternatively or in addition, there may be customization for user actions.
Operation i. Manager opens a chat channel, for example, a team chat channel.
Operation ii. Manager provides a reserved input e.g., types the ‘@’ sign e.g. in the chat text
Operation iii. System queries for list of KPIs that chat participates have, that may be referenced by the manager
Operation iv. System displays the manager with KPI list
Operation v. Manager selects a KPI from the list
Operation vi. A graphical and textual representation (e.g., of the KPI selected) is shown to the manager in chat text.
Operation vii. When the manager sends the message, a graphical contextual representation may be shown for each of chat users and manager. The context is the user viewing the message, so each user may see their own graphical representation. Presenting the referenced KPI for the user may include all or any subset of the following operations, suitably ordered e.g., as follows:
vii-1. User opens chat window
vii-2. System identifies that KPI is referenced
vii-3. System queries for current user KPI status
vii-4. System shows graphic representation of KPI to user based on current status.
viii. According to certain embodiments, all users click on KPIs and are, responsively, presented with contextual actions for those KPIs. Users who are managers may click on an KPI and may get contextual actions for specific KPIs and (e.g. if in personal user chat) the actions may be in the user contexts too.

According to certain embodiments, a team manager may write a single line, generic to all users, in a conversation referencing, say, a KPI or inventor and, responsively, each of the team's members gets the generic line not as is, but, instead, personalized to them. For example, the generic line might be: “work on supply chain problems for the most scarce item, in inventories you are responsible for” and team member Joe would, typically during the chat, then receive from the platform a list of items not in stock in the 2 inventories associated with Country 1, the geographical area he is responsible for, which might be lasers and fans, whereas team member Joy would, also typically during the chat, receive from the platform a list of items not in stock in the 3 inventories associated with Country 2, the geographical area she is responsible for, such as perhaps CPUs, lifting forks, and lighting fixtures.

It is appreciated that terminology such as “mandatory”, “required”. “need” and “must” refer to implementation choices made within the context of a particular implementation or application described herewithin for clarity and are not intended to be limiting since in an alternative implantation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such: at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein: and (b) outputting the solution.

The system may if desired be implemented as a network—e.g. web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may for example comprise changing the state or condition or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS. Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example and instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. Laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include apparatus whether hardware, firmware or software which is configured to perform, enable or facilitate that operation or to enable, facilitate or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g. operation described herein may have all characteristics and attributes described or illustrated herein or according to other embodiments, may have any subset of the characteristics or attributes described herein.

1. A system supporting conversations between users, the apparatus comprising:
computer memory including plural records of plural conversations between users respectively; and
a hardware processor providing conversation functionality which enables at least first and second web platform users to conduct at least one conversation C with one another;
wherein the hardware processor is configured, responsive to mention of at least one business object in the conversation C, to show, to the first user, data pertaining to said business object which is specific to the first user; and to show, to the second user, data pertaining to said business object which is specific to the second user.

2. A system according to claim 1 wherein the hardware processor is also configured to enable the first and second users to perform respective actions on said at least one business objects and wherein data pertaining to said actions is stored in said computer memory in a record of said conversation C.

3. A system according to claim 1 wherein an action performed by the first user comprises sending a project report reflecting progress on aspects of a project which pertain to the first user, to at least one user, other than the first user, who is participating in the conversation C.

4. A system according to claim 1 wherein the hardware processor shows data to at least said first user when the first user hovers over the mention of the business object in conversation C.

5. A system according to claim 1 wherein the business object mentioned in the conversation comprises a KPI which has different values for the first user and for the second user, and wherein the hardware processor shows the values of the KPI for the first user, to the first user, and shows the values of the KPI for the second user, to the second user.

6. A system according to claim 1 wherein the business object mentioned in the conversation comprises one of the following: a Campaign, a Learning Item, a Challenge, a Leaderboard (or scoreboard showing names and current scores for plural competitors e.g. system users), and a Coaching Activity.

7. A system according to claim 1 wherein at least one user's rooms with information on each room loads in real time because the system maintains, in cache, a list of rooms for each user, including metadata regarding said rooms.

8. A system according to claim 7 wherein the metadata is updated in real time.

9. A system according to claim 1 wherein the hardware processor includes a conversation service and conversation user interface, and wherein updates of conversation rooms and users are pushed from the conversation service to the conversation user interface.

10. A system according to claim 1 wherein at least one user performs at least one action from among said actions without exiting the conversation.

11. A method supporting conversations between users, the method comprising:
Providing computer memory including plural records of plural conversations between users respectively; and
Using a hardware processor to provide conversation functionality which enables at least first and second web platform users to conduct at least one conversation C with one another;
wherein the hardware processor is configured, responsive to mention of at least one business object in the conversation C, to show, to the first user, data pertaining to said business object which is specific to the first user; and to show, to the second user, data pertaining to said business object which is specific to the second user.

12. A computer program product, comprising a non-transitory tangible computer readable medium having computer readable program code embodied therein, said computer readable program code adapted to be executed to implement a method supporting conversations between users, the method comprising:
Providing computer memory including plural records of plural conversations between users respectively; and
Using a hardware processor to provide conversation functionality which enables at least first and second web platform users to conduct at least one conversation C with one another;
wherein the hardware processor is configured, responsive to mention of at least one business object in the conversation C, to show, to the first user, data pertaining to said business object which is specific to the first user; and to show, to the second user, data pertaining to said business object which is specific to the second user.
